(19) United States
(12) Patent Application Publication
(10) Pub. No.: US 2012/0167220 A1
(43) Pub. Date: Jun. 28, 2012

(54) SEED INFORMATION COLLECTING DEVICE AND METHOD FOR DETECTING MALICIOUS CODE LANDING/HOPPING/DISTRIBUTION SITES

(75) Inventors: Jong-Il Jeong, Seongnam-Si (KR); Chae-Tae Im, Seoul (KR); Joo-Hyung Oh, Seoul (KR); Hong-Koo Kang, Gyeonggi-do (KR); Jin-Kyung Lee, Seoul (KR); Byoung-Ik Kim, Seongnam-Si (KR); Seung-Goo Ji, Seoul (KR); Tai-Jin Lee, Seoul (KR); Hyun-Cheol Jeong, Seoul (KR)

(73) Assignee: KOREA INTERNET & SECURITY AGENCY, Seoul (KR)

(21) Appl. No.: 13/304,986

(22) Filed: Nov. 28, 2011

(30) Foreign Application Priority Data
Dec. 23, 2010 (KR) 10-2010-0133523

(51) Int. Cl. G06F 11/00

(52) U.S. Cl. 726/24

(57) ABSTRACT

Provided is seed information collecting device for detecting malicious code landing/hopping/distribution sites. The device comprises: a seed information collecting module collecting social issue keywords from a seed information collecting channel and collecting address information of potential malicious code landing/hopping/distribution sites using the collected social issue keywords; a web source code collecting module collecting web source code of the potential malicious code landing/hopping/distribution sites using the address information of the potential malicious code landing/hopping/distribution sites collected by the seed information collecting module; and a policy management module managing collection policies of the seed information collecting module and the web source code collecting module.

This application claims priority from Korean Patent Application No. 10-2010-0133523 filed on Dec. 23, 2010 in the Korean Intellectual Property Office, the disclosure of which is incorporated herein by reference in its entirety.

### BACKGROUND

1. Field of the Inventive Concept

The present invention relates to a seed information collecting device and method for detecting malicious code landing/hopping/distribution sites.

2. Description of the Related Art

Malicious code is a set of malicious or ill-intentioned software. It is a general term that refers to all types of software potentially dangerous for users and computers, such as viruses, worms, spyware, and dishonest adware. Malware, short for malicious software, is software designed to perform malicious activities, including disrupting the system against a user's intent and benefit and leaking information. In Korea, malware is translated as ‘malicious code,’ and malicious code is a wider concept that encompasses viruses characterized by self replication and file contamination.

Malicious code is distributed and spread widely through networks. If the distribution and spreading channels of malicious code can be identified systematically, the spread of the malicious code can be prevented effectively, thereby reducing the damage caused by the malicious code. For this reason, a method of identifying the spreading channels of malicious code is being actively researched.

### SUMMARY

Aspects of the present invention provide a seed information collecting device which can actively detect, in advance, potential malicious code landing/hopping/distribution sites and collect web source code of the potential malicious code landing/hopping/distribution sites.

Aspects of the present invention also provide a seed information collecting method employed to actively detect, in advance, potential malicious code landing/hopping/distribution sites and collect web source code of the potential malicious code landing/hopping/distribution sites.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a seed information collecting device for detecting malicious code landing/hopping/distribution sites, the device comprising: a seed information collecting module collecting social issue keywords from a seed information collecting channel and collecting address information of potential malicious code landing/hopping/distribution sites using the collected social issue keywords; a web source code collecting module collecting web source code of the potential malicious code landing/hopping/distribution sites using the address information of the potential malicious code landing/hopping/distribution sites collected by the seed information collecting module; and a policy management module managing collection policies of the seed information collecting module and the web source code collecting module.

According to another aspect of the present invention, there is provided a seed information collecting method for detecting malicious code landing/hopping/distribution sites, the method comprising: collecting social issue keywords using one or more real-time search word lists of one or more Internet search engines; collecting address information of potential malicious code landing/hopping/distribution sites by querying the Internet search engines using the collected social issue keywords; and accessing the potential malicious code landing/hopping/distribution sites using the address information of the potential malicious code landing/hopping/distribution sites and collecting web source code of the potential malicious code landing/hopping/distribution sites.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram of a seed information collecting device for detecting malicious code landing/hopping/distribution sites according to an embodiment of the present invention; and

FIGS. 2 through 4 are flowcharts illustrating the operation of the seed information collecting device that is, a seed information collecting method for detecting malicious code landing/hopping/distribution sites according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. The same reference numbers indicate the same components throughout the specification. In the attached figures, the thickness of layers and regions is exaggerated for clarity.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

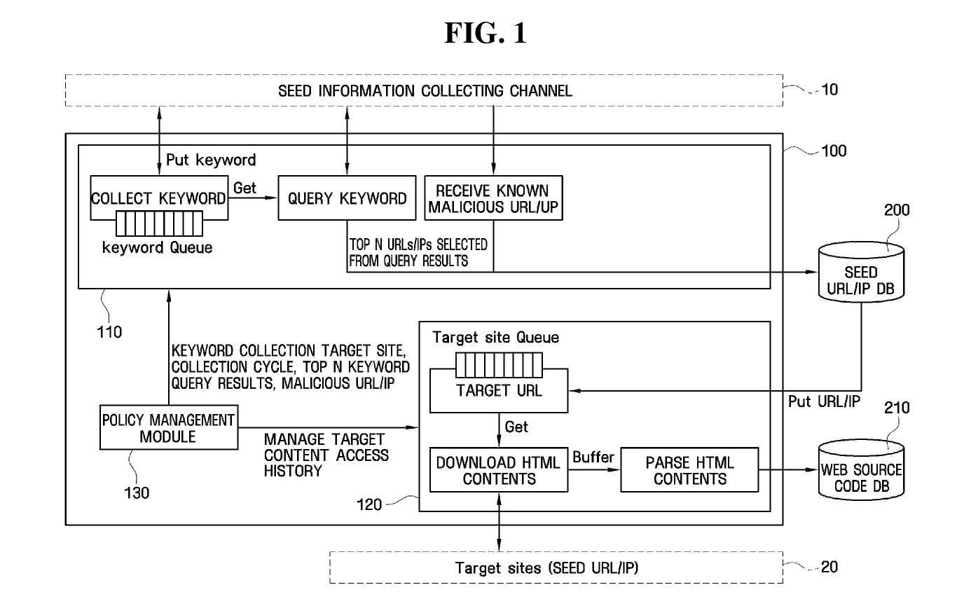

Hereinafter, a seed information collecting device and method for detecting malicious code landing/hopping/distribution sites according to an embodiment of the present invention will be described with reference to FIGS. 1 through 4.

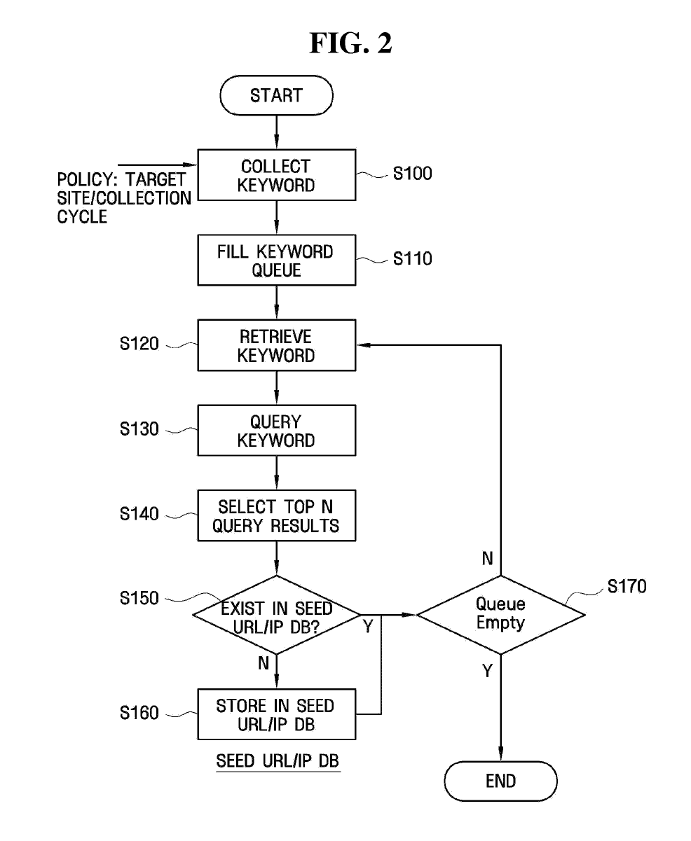

FIG. 1 is a block diagram of a seed information collecting device 100 for detecting malicious code landing/hopping/distribution sites according to an embodiment of the present invention. FIGS. 2 through 4 are flowcharts illustrating the operation of the seed information collecting device 100, that is, a seed information collecting method for detecting malicious code landing/hopping/distribution sites according to an embodiment of the present invention.

In the present specification, a malicious code landing/hopping/distribution site may denote at least one of landing, hopping, and distribution sites of malicious code. Specifically, the landing site of the malicious code may be a site in which the malicious code is created, and the hopping site of the malicious code may be an intermediate site between the landing site and the distribution site. The distribution site of the malicious code may be a site which actually distributes the malicious code to users. In addition, a potential malicious code landing/hopping/distribution site may denote a site that can become at least one of the landing, hopping, and distribution sites of the malicious code.

Referring to FIG. 1, the seed information collecting device 100 for detecting malicious code landing/hopping/distribution sites according to the current embodiment may include a seed information collecting module 110, a web source code collecting module 120, a policy management module 130, a seed information database (DB) 200, and a web source code DB 210.

The seed information collecting module 110 may collect social issue keywords from a seed information collecting channel 10 and collect address information of potential malicious code landing/hopping/distribution sites using the collected social issue keywords. Here, a social issue keyword may denote a keyword expressing an issue that becomes the focus of public attention for a certain period of time. The address information of a potential malicious code landing/hopping/distribution site may be information that contains at least one of a uniform resource locator (URL) and an Internet protocol (IP) of the potential malicious code landing/hopping/distribution site.

This operation of the seed information collecting module 110 will now be described in greater detail with reference to FIGS. 1 and 2.

Referring to FIG. 2, the seed information collecting module 110 collects social issue keywords using one or more real-time search word lists of one or more Internet search engines (operation S100). Then, the seed information collecting module 110 fills a keyword queue with the collected social issue keywords (operation S110).

Specifically, the seed information collecting module 110 may collect social issue keywords with reference to one or more real-time search word lists of one or more Internet search engines (examples of major Internet search engines currently available in Korea include Naver, Daum, Yahoo, and Google) by using application programming interfaces (APIs) provided by the Internet search engines. Here, the policy management module 130 may provide a collection policy for target sites of the seed information collecting module 110 and manages the collection policy of the seed information collecting module 110 such that the seed information collecting module 110 continuously performs a collection operation at intervals of a predetermined time (e.g., ten minutes).

After collecting the social issue keywords, the seed information collecting module 110 retrieves the collected social issue keywords one by one from the keyword queue (operation S120). The seed information collecting module 110 collects address information of sites found by querying one or more Internet search engines as address information of potential malicious code landing/hoping/distribution sites (operation S130). From the collected address information of the potential malicious code landing/hopping/distribution sites, the seed information collecting module 110 selects address information of top N sites (operation S140). Here, the policy management module 130 may manage the collection policy of the seed information collecting module 110 such that the seed information collecting module 110 collects address information of N (an arbitrary number that can be determined by an administrator) sites selected in order of recency or relevance to each subject from search results of one or more Internet search engines as address information of potential malicious code landing/hopping/distribution sites. As described above, the address information of the top N sites may be the URLs or IPs thereof.

After selecting the address information of the top N sites from the address information of the potential malicious code landing/hopping/distribution sites, the seed information collecting module 110 compares the selected address information of the top N sites with address information stored in the seed information DB 200 (operation S150). If the address information of the top N sites is new address information, the seed information collecting module 110 stores the address information of the top N sites in the seed information DB 200 (operation S160). If the address information of the top N sites already exists in the seed information DB 200, the seed information collecting module 110 repeats the process of retrieving the collected social issue keywords one by one from the keyword queue until the keyword queue becomes empty (operation S170).

When an issue attracts public attention, a representative keyword representing the issue is put on a real-time search word list of an Internet search engine (often called a portal site). Since the representative keyword put on the real-time search word list is continuously entered by users of the Internet search engine, it becomes a subject of great public attention.

A malicious code creator will want malicious code that he or she created to be distributed as widely as possible. Thus, for the malicious code creator, the social issue keyword can be good bait for distributing the malicious code. That is, if the malicious code creator creates a malicious code distribution site related to the social issue keyword, many users will access the created malicious code distribution site by entering the social issue keyword. Thus, for the malicious code creator, the social issue keyword can be good bait for distributing the malicious code that he or she created.

In this regard, continuously collecting social issue keywords and detecting, in advance, whether sites found using the collected social issue keywords are related to malicious code by using the seed information collecting device 100 according to the current embodiment are very meaningful in that potential malicious code landing/hopping/distribution sites are actively collected and detected. Such an active collection process can prevent the distribution of malicious code through malicious code landing/hopping/distribution sites. Furthermore, the seed information collecting device 100 according to the current embodiment continuously collects social issue keywords at intervals of a predetermined time. Thus, potential malicious code landing/hopping/distribution sites can be detected early.

Generally, malicious code landing/hopping/distribution sites are created, after an issue becomes the focus of public attention, as contents related to the issue in order to lure users. The seed information collecting device 100 according to the current embodiment collects address information of only N sites selected in order of recency or relevance to each subject from query results of an Internet search engine. This can complement a reduction in detection efficiency due to collection of an excessive amount of address information.

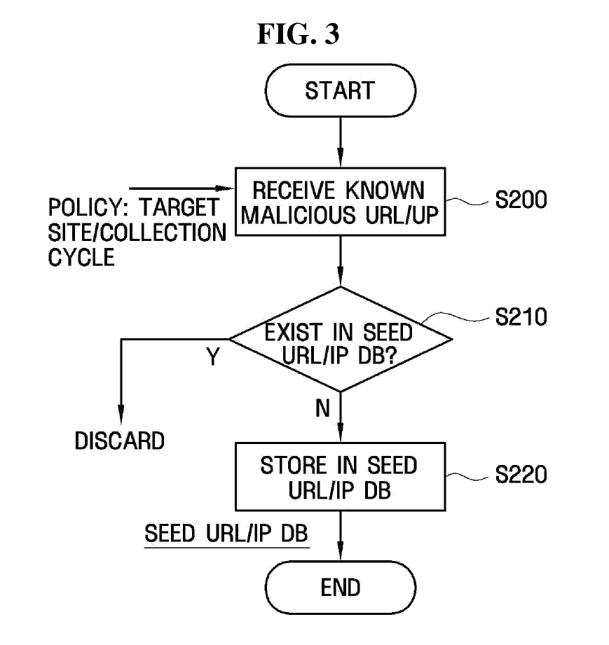

Referring back to FIG. 1, the seed information collecting module 110 may collect address information of known malicious code sites from the seed information collecting channel 10 and store the collected address information in the seed information DB 200. This operation of the seed information collecting module 110 will now be described in greater detail with reference to FIGS. 1 and 3.

Referring to FIG. 3, the seed information collecting module 110 collects address information of known malicious code sites from the seed information collecting channel 10 (operation S200). Here, the policy management module 130 may also provide a policy for target sites of the seed information collecting module 110 and manage the collection policy of the seed information collecting module 110 such that the seed information collecting module 110 performs a collection operation at intervals of a predetermined time.

After collecting the address of the known malicious code sites, the seed information collecting module 110 compares the collected address information of the known malicious code sites with the address information stored in the seed information DB 200 (operation S210). If the address information of the known malicious code sites is new information, the seed information collecting module 110 stores the collected address information in the seed information DB 200 (operation S220). If the address information of the known malicious code sites already exists in the seed information DB 200, the seed information collecting module 110 discards the address information of the known malicious code sites (operation S220). In this way, the seed information collecting device 100 according to the current embodiment collects address information of known malicious code sites as well as address information of potential malicious code landing/hopping/distribution sites. Thus, the seed information collecting device 100 has the advantage of identifying malicious code landing/hopping/distribution sites more effectively.

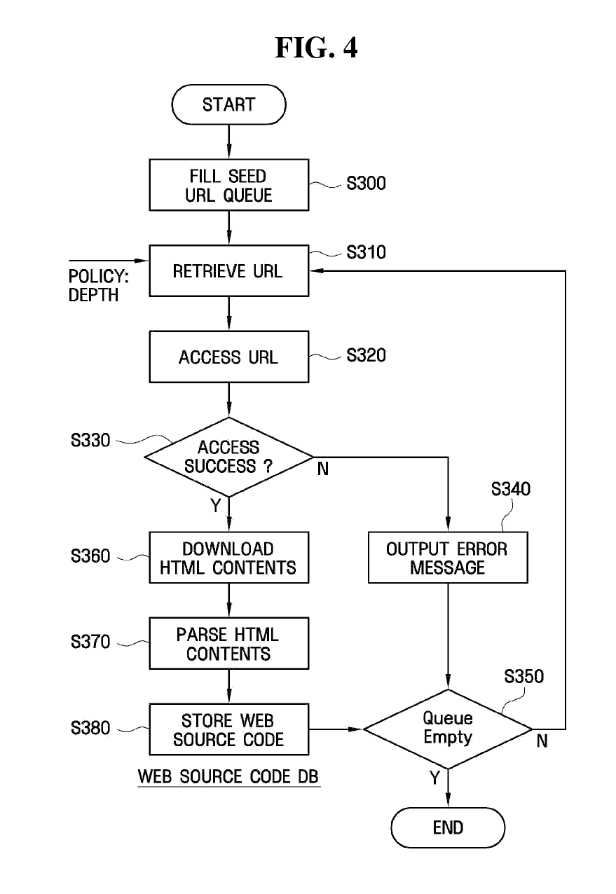

Referring back to FIG. 1, the web source code collecting module 120 may collect web source code of potential malicious code landing/hopping/distribution sites or web source code of known malicious code sites using address information of the potential malicious code landing/hopping/distribution sites or address information of the known malicious code sites. The operation of the web source code collecting module 120 will now be described in greater detail with reference to FIGS. 1 and 4.

Referring to FIG. 4, the web source code collecting module 120 retrieves address information from the seed information DB 200 and fills a target site queue with the retrieved address information (operation S300). Then, the web source code collecting module 120 fetches the retrieved address information one by one from the target site queue (operation S310). Here, the policy management module 130 may provide a collection policy (depth) of the web source code collecting module 120.

The web source code collecting module 120 accesses a potential malicious code landing/hopping/distribution site (indicated by reference numeral 20 in FIG. 1) or a known malicious code site (indicated by reference numeral 20 in FIG. 1) by using the fetched address information. When failing to access the site, the web source code collecting module 120 outputs an error message and fetches the retrieved address information one by one from the target site queue until the target site queue becomes empty (operations S340 and S350). When successfully accessing the site, the web source code collecting module 120 downloads HTML contents from the site (operation S360) and then parses the downloaded HTML contents (operation S370).

Through the parsing process, a redirection HTML tag, object insertion code, and script code may be extracted from the HTML contents of the site accessed by the web source code collecting module 120. Extraction conditions for the redirection HTML tag, the object insertion code, and the script code may be as shown in Table 1 below.

TABLE 1

| Extraction | |
|---|---|
| Target | Extraction Conditions |
| HTML Tag | URL request tag |
| | A, APPLET, AREA, BASE, BLOCKQUOTE, FORM, |
| | FRAME, HEAD, IFRAME, IMG, INPUT, INS, LINK, |
| | META, OBJECT, SCRIPT |
| | URL request attributes |
| | href, codebase, uri, cite, action, longdesc, src, profile, |
| | usemap, url, content, classid, data |
| Object | clsid, parameter, codebase, filename, function |
| Script | Entire source code |

The site's web source code extracted as described above is stored in the web source code DB 210 and may later be used to determine whether the site is a malicious code landing/hopping/distribution site (operation S380).

Referring back to FIG. 1, the policy management module 130 may manage the collection policies of the seed information collecting module 110 and the web source code collecting module 120. These collection policies have been described above in the description of the seed information collecting module 110 and the web source code collecting module 120, and thus a repetitive description thereof will be omitted.

A seed information collecting device according to an embodiment of the present invention continuously collects social issue keywords and detects, in advance, whether sites found using the social issue keywords are related to malicious code. This is very meaningful in that potential malicious code landing/hopping/distribution sites are actively collected and detected. Such an active collection process can prevent the distribution of malicious code through malicious code landing/hopping/distribution sites. Furthermore, the seed information collecting device according to the embodiment of the present invention continuously collects social issue keywords at intervals of a predetermined time. Thus, potential malicious code landing/hopping/distribution sites can be detected early.

Generally, malicious code landing/hopping/distribution sites are created, after an issue becomes the focus of public attention, as contents related to the issue in order to lure users. The seed information collecting device according to the embodiment of the present invention collects address information of only N sites selected in order of recency or relevance to each subject from query results of an Internet search engine. This can complement a reduction in detection efficiency due to collection of an excessive amount of address information.

The seed information collecting device according to the embodiment of the present invention collects address information of known malicious code sites as well as address information of potential malicious code landing/hopping/distribution sites. Thus, the seed information collecting device has the advantage of identifying malicious code landing/hopping/distribution sites more effectively.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A seed information collecting device for detecting malicious code landing/hopping/distribution sites, the device comprising:
a seed information collecting module collecting social issue keywords from a seed information collecting channel and collecting address information of potential malicious code landing/hopping/distribution sites using the collected social issue keywords;
a web source code collecting module collecting web source code of the potential malicious code landing/hopping/distribution sites using the address information of the potential malicious code landing/hopping/distribution sites collected by the seed information collecting module; and
a policy management module managing collection policies of the seed information collecting module and the web source code collecting module.

2. The device of claim 1, wherein the address information comprises at least one of a uniform resource locator (URL) and an Internet protocol (IP).

3. The device of claim 1, wherein the social issue keywords collected by the seed information collecting module comprise one or more real-time search word lists of one or more Internet search engines that the seed information collecting module collects using application programming interfaces (APIs) provided by the Internet search engines.

4. The device of claim 3, wherein the policy management module manages the collection policy of the seed information collecting module such that the seed information collecting module continuously collects the real-time search word lists at intervals of a predetermined time.

5. The device of claim 1, wherein when collecting the address information of the potential malicious code landing/hopping/distribution sites using the collected social issue keywords, the seed information collecting module collects results obtained by querying one or more Internet search engines using the social issue keywords as the address information of the potential malicious landing/hopping/distribution sites.

6. The device of claim 5, wherein the policy management module manages the collection policy of the seed information collecting module such that the seed information collecting module collects address information of N sites selected in order of recency or relevance to each subject from the query results of the Internet search engines.

7. The device of claim 1, wherein when collecting the web source code of the potential malicious code landing/hopping/distribution sites, the web source code collecting module accesses each of the potential malicious code landing/hopping/distribution sites using the address information of the potential malicious code landing/hopping/distribution sites, downloads HTML contents from each of the potential malicious code landing/hopping/distribution sites, and collects the web source code of each of the potential malicious code landing/hopping/distribution sites by parsing the downloaded HTML contents.

8. The device of claim 7, wherein when collecting the web source code of each of the potential malicious code landing/hopping/distribution sites by parsing the downloaded HTML contents, the web source code collecting module extracts a redirection HTML tag, object insertion code and script code from the parsed HTML contents and collects the extracted redirection HTML tag, object insertion code and script code.

9. A seed information collecting method for detecting malicious code landing/hopping/distribution sites, the method comprising:
collecting social issue keywords using one or more real-time search word lists of one or more Internet search engines;
collecting address information of potential malicious code landing/hopping/distribution sites by querying the Internet search engines using the collected social issue keywords; and
accessing the potential malicious code landing/hopping/distribution sites using the address information of the potential malicious code landing/hopping/distribution sites and collecting web source code of the potential malicious code landing/hopping/distribution sites.

10. The method of claim 9, wherein the address information of the potential malicious code landing/hopping/distribution sites comprises address information of N sites selected in order of recency or relevance to each subject from the query results of the Internet search engines.

11. The method of claim 9, wherein the collecting of the web source code of the potential malicious code landing/hopping/distribution sites comprises:
downloading HTML contents from each of the potential malicious code landing/hopping/distribution sites; and
collecting web source code of each of the potential malicious code landing/hopping/distribution sites by parsing the downloaded HTML contents.

12. The method of claim 11, wherein the collecting of the web source code of each of the potential malicious code landing/hopping/distribution sites by parsing the downloaded HTML contents comprises extracting a redirection HTML tag, object insertion code and script code from the parsed HTML contents and collecting the extracted redirection HTML tag, object insertion code and script code.
